(19) United States
(12) Patent Application Publication
(10) Pub. No.: US 2006/0117122 A1
(43) Pub. Date: Jun. 1, 2006

(54) Method and apparatus for conditionally obfuscating bus communications

(75) Inventor: Eric C. Hannah, Pebble Beach, CA (US)

Correspondence Address: SCHWABE, WILLIAMSON & WYATT, PACWEST CENTER, SUITE 1900, 1211 S.W. FIFTH AVE., PORTLAND, OR, 97204, US

(73) Assignee: Intel Corporation

(21) Appl. No.: 10/982,219

(22) Filed: Nov. 4, 2004

(51) Int. Cl. G06F 13/00

(52) U.S. Cl. 710/100; 712/227; 710/113; 380/225; 370/359

(57) ABSTRACT

Illustrative embodiments of the present invention include, but are not limited to, a system (including associated apparatus and methods practiced thereon) for conditionally obfuscating internal bus communications once legitimate device testing is complete.

### FIELD OF THE INVENTION

Disclosed embodiments of the present invention relate to data processing. More specifically, embodiments of the present invention related to a method and apparatus for conditionally obfuscating bus communications.

### BACKGROUND INFORMATION

With the growth of the Internet coupled with the proliferation of digital computing devices, the amount of digital information that is generated and exchanged continues to grow exponentially. One industry that is fueling a large portion of this growth is the entertainment and recording industry. As more content providers such as artists, publishers and recording studios race to meet consumer demand for digitized audio and video content, the need for additional audio and video playback and storage devices also increases. However, as consumer demand for high quality digital audio and video content continues to increase, so to do the concerns of copyright owners regarding the illegal copying, manipulation and/or distribution of such digital content.

In the past, software-based digital rights management systems have been employed to protect digital content while stored on playback devices. Although to some extent this method has worked to protect digital content from being illegally accessed, content “pirates” continue to become more resourceful finding ways to circumvent existing copy protection schemes. Although copyright holders would like to prevent access to critical internal operations of playback and storage devices, manufacturers of such devices continue to require adequate access to critical internal operations of the devices in order to test and debug products prior to their release to consumers.

### BRIEF DESCRIPTION OF THE DRAWINGS

Embodiments of the invention are illustrated by way of example and not by way of limitation in the figures of the accompanying drawings, in which the like references indicate similar elements and in which:

FIG. 1 is a flow diagram illustrating an operational overview of the present invention in accordance with one embodiment;

FIG. 2 illustrates an overview of an apparatus of the present invention in accordance with one embodiment;

FIG. 3 illustrates an embodiment of the invention in which obfuscation circuit 205 is integrated with driver 202;

FIG. 4 illustrates an embodiment of the invention in which obfuscation circuit 205 represents an encryption module and a decryption module;

FIG. 5 illustrates obfuscation circuit 205 used in conjunction with a communication bus based upon differential transmission lines;

FIG. 6 illustrates an embodiment of the invention in which obfuscation circuit 205 and control circuit 508 cooperatively and conditionally change the physical signaling mode of communication bus 406; and

FIG. 7 illustrates a block diagram of an example electronic system 700 incorporating obfuscation circuit 205 and at least one integrated circuit.

### DETAILED DESCRIPTION OF EMBODIMENTS OF THE INVENTION

Illustrative embodiments of the present invention include, but are not limited to a method and apparatus for conditionally obfuscating bus communications. In the following detailed description, numerous specific details are set forth in order to provide a thorough understanding of embodiments of the present invention. However, those skilled in the art will understand that such embodiments may be practiced without these specific details. In other instances, well known methods, procedures, components, and circuits have not been described in detail.

Although various discrete operations will be described herein, the mere order of description should not be construed as to imply that these operations are necessarily performed in the order they are presented.

Furthermore, reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention, although they may. Moreover, the particular features, structures, or characteristics described may be combined in any suitable manner in one or more embodiments. Lastly, the terms “comprising”, “including”, “having”, and the like, as used in the present application, are intended to be synonymous.

Although it is important for content owners/providers to be able to limit unauthorized consumer access to digital content within computing devices, it is equally important for the manufacturers of such devices to have adequate access to critical internal operations of the devices in order to test and debug products prior to their release to consumers. As such, a system (including associated apparatus and methods practiced thereon) is described herein for conditionally obfuscating internal bus communications once legitimate device testing is complete. Accordingly, manufacturers can freely test and debug playback devices in a controlled environment, while the ability to externally measure internal bus communications can be prevented or otherwise circumscribed before the devices are shipped to consumers.

In accordance with one embodiment of the invention, a computing device may be equipped with a signal driver, a communication bus, and an obfuscation circuit that may be conditionally activated to transition the computing device from a first testing state to a second consumer protect state. The obfuscation circuit of the present invention may include one or more physical devices, such as a discrete or integrated circuit, that operates to conditionally prevent external measurement of data signals on one or more communication busses within the computing device. In one embodiment, the obfuscation circuit may include or otherwise be represented by a programmable fuse or antifuse device to influence when the computing device transitions from a first testing state to a second consumer protect state.

As used herein, the term “computing device” is intended to represent a broad class of general purpose or specially designed electronic devices. Such electronic devices may include but shall not be limited to a wireless mobile phone, a personal digital assistant, an audio/video controller, a DVD player, a digital audio player, a personal computer, a network router, a set-top box, a server, and so forth. A computing device need not include a central processing unit or arithmetic logic unit, but it may. In one embodiment of the invention, the obfuscation circuit is employed within a processor to conditionally prevent measurement of data signals on one or more communication busses internal or external to the processor.

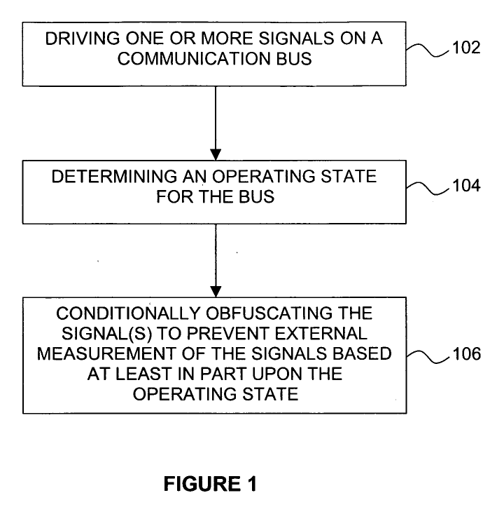

FIG. 1 is a flow diagram illustrating an operational overview of the present invention in accordance with one embodiment. In the illustrated embodiment, one or more signals may be driven onto a communication bus at block 202 and an operating state for the bus may be determined at block 204. At block 206, the signal(s) on the communication bus may be conditionally obfuscated to prevent external measurement of the signals based at least in part upon the determined operating state.

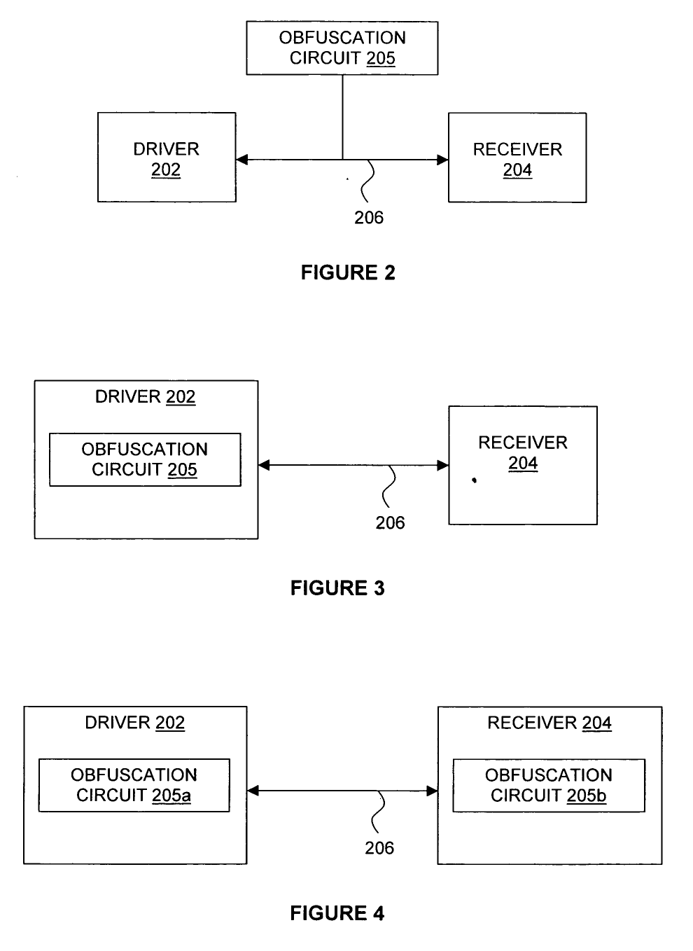

FIG. 2 illustrates an overview of an apparatus of the present invention in accordance with one embodiment. More specifically, FIG. 2 depicts a signal driver 202 and a signal receiver 204 communicatively coupled together via communication bus 206. Signal driver 202 is intended to represent a broad spectrum of signal generators equipped to place a signal on communication bus 206. Similarly, receiver 204 is intended to represent a broad spectrum of circuit elements/devices equipped to receive signals off of communication bus 206. Additionally, obfuscation circuit 205 may be communicatively coupled to communication bus 206 to conditionally prevent external measurement of signals present on the communication bus. In one embodiment, obfuscation circuit 205 may be coupled directly or one or both of driver 202 and receiver 204. FIG. 3 illustrates an embodiment of the invention in which obfuscation circuit 205 is integrated with driver 202.

In one embodiment, obfuscation circuit 205 may include or otherwise operate in cooperation with an encryption/decryption circuit or logic block to conditionally prevent external measurement of data signals on communication bus 206. FIG. 4 illustrates an embodiment of the invention in which obfuscation circuit 205 represents an encryption module and a decryption module. As illustrated, obfuscation circuit 205 may represent an encryption component 205a coupled to driver 202 and a decryption component 205b coupled to receiver 204 to conditionally encrypt and decrypt communications on communication bus 206. In accordance with at least one embodiment of the present invention, operation of encryption component 205a and decryption component 205b may be conditioned upon whether communication bus 206 is intended to operate in a test state, in which measurement of data signals on the bus (e.g., by probes and logic analyzers) is possible, and a consumer protect state, in which measurement of data signals on the bus is prevented.

Although the act of encrypting data on communications buses may afford a high level of bus security, encryption implementations typically require large amounts of circuitry on both ends of each bus to be protected. Additionally, some of the strongest or most desirable encryption methods may be subject to significant license fees, which may in turn increase production costs. Accordingly, obfuscation circuit 205 may be implemented without the use of encryption circuitry.

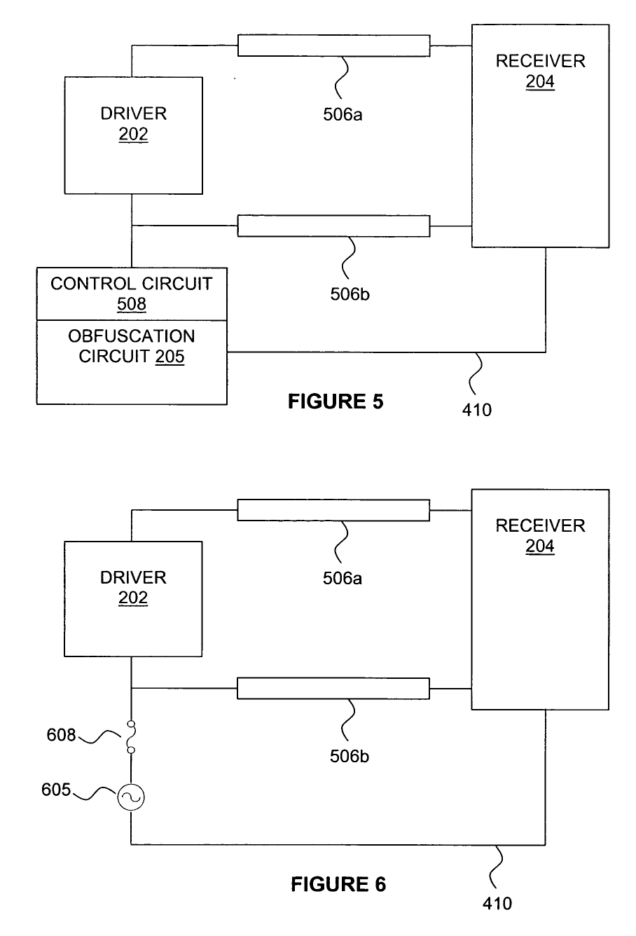

FIG. 5 illustrates obfuscation circuit 205 used in conjunction with a communication bus based upon differential transmission lines. As shown, driver 202 is coupled to receiver 204 by differential transmission lines 506a and 506b (together referred to as communication bus 406). In one embodiment, transmission lines 506a and 506b may represent parallel copper traces disposed on or within an integrated circuit or PC board that share a common ground plane represented as feedback path 410. Additionally, control circuit 508 may be coupled to obfuscation circuit 205 and communication bus 406 as shown to indicate whether the bus is intended to operate in a test mode or a consumer protect mode. Control circuit 508 may represent a wide variety of analog circuit elements and/or digital logic to indicate such a bus state. For example, control circuit 508 may represent a fuse/antifuse which may be programmed (e.g., through application of a programming current), or a control register which may be programmed (e.g., with one or more bit patterns) or cleared to indicate an operating state for communication bus 506.

FIG. 6 illustrates an embodiment of the invention in which obfuscation circuit 205 and control circuit 508 cooperatively and conditionally change the physical signaling mode of communication bus 406. In the illustrated embodiment, obfuscation circuit 205 is represented as a signal generator 605 and control circuit 508 is represented as an antifuse device 608. A fuse normally appears as a short circuit until a prescribed programming current is applied at which time the fuse “blows” and appears as an open circuit. On the other hand, an antifuse normally appears as an open circuit until force a prescribed programming current is applied. In a poly-diffusion antifuse the high current density causes a large power dissipation in a small area, which melts a thin insulating dielectric between polysilicon and diffusion electrodes and forms a thin, permanent, and resistive silicon link.

In one embodiment, signal generator 605 may operate to generate a randomized noise signal that is conditionally driven onto communication bus 206 based upon the state of antifuse device 608. For example, if control circuit 508 represents and antifuse device operating under normal current conditions, it would appear as an open circuit resulting in only driver 202 driving signals onto communication bus 406. However, once a sufficient programming current is applied to the antifuse device such that it blows, the antifuse would appear as a short circuit causing signal generator 605 to drive a secondary signal onto communication bus 406. In another embodiment, control circuit 508 may represent a fuse device coupled with signal generator 605 such that signal generator 605 drives a secondary signal onto communication bus 406 upon a sufficient programming current being applied to the fuse causing it to blow.

The embodiments of FIG. 5 and FIG. 6 may have particular applicability in preventing electromagnetic couplers from measuring or otherwise analyzing data signals present on communication bus 406. Electromagnetic couplers (EMC) are being designed to provide adequate tapping of transmission lines at 1.6 Giga-transfers per second and above without significant impact such as that related to impedance discontinuity effects. In order to probe the differential transmission lines of communication bus 406, an EMC probe will likely require two independent couplers and receivers to produce the resulting differential data signal as EMC probes only detect single-ended signals. Additionally EMC probes generally act as high pass filters and do not have direct contact to PC board ground planes. Thus, in accordance with one embodiment of the invention, obfuscation circuit 205 may be equipped to add a large common-mode signal (e.g., having a broad spectrum random character) to each of the differential signal lines to confuse EMC probes. The EMC probe which is intrinsically a single-ended detector will see the combination of the differential signal with the large and random common-mode signal. Because the EMC signal delivered to its receiver is the derivative of the desired signal waveform, is of low amplitude with low signal to noise ratio, and is of very short time duration, it is easy to overload and confuse the EMC receiver. In one embodiment, receiver 204 should have little difficulty rejecting the added common-mode as since receiver 204 has ground plane reference available to it (e.g. as illustrated by feedback path 410).

The embodiments illustrated in FIG. 5 and FIG. 6 may be considered advantageous over encryption based embodiments in that there only needs to be a random noise/number generator on the transmitting side of the communication bus. Unlike encryption systems, the receivers do not need to deconvolve the masking signal from the real signal and there is no need for sophisticated key exchange operations.

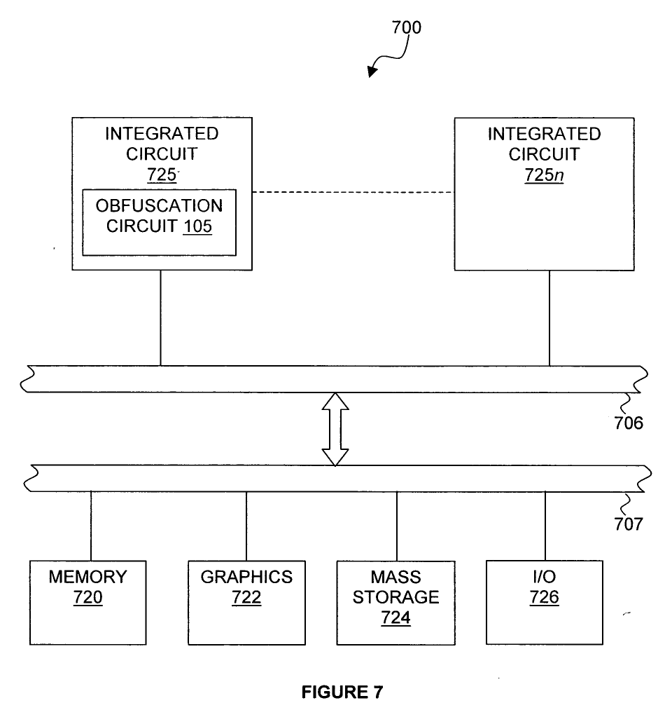

In one embodiment, obfuscation circuit 205 may be used in a system containing two or more integrated circuits to prevent measurement of signals transmitted on communication busses between such integrated circuits. FIG. 7 illustrates a block diagram of an example electronic system 700 incorporating obfuscation circuit 205 and at least one integrated circuit. In one embodiment, electronic system 700 may include integrated circuits 725-725n communicatively coupled to communication bus 706, which in turn may be communicatively coupled to communication bus 707. Examples of bus 706 and 707 include, but are not limited to, a peripheral control interface (PCI) bus, and an industry standards architecture (ISA) bus, and so forth. In one embodiment, communication bus 706 and/or bus 707 may employ differential signaling over differential transmission lines. In one embodiment, one or more of integrated circuits 725-725n may represent a processor, where a processor may include, but is not limited to, a microprocessor, a graphics processor, and a digital signal processor.

The electronic system 800 may also include other components such as main memory 720, a graphics processor 722, a mass storage device 724, and an input/output module 726 coupled to each other by way of the bus 707, as shown. Examples of the memory 720 may include, but are not limited to, static random access memory (SRAM) and dynamic random access memory (DRAM). Examples of mass storage device 724 may include, but are not limited to, a hard disk drive, a compact disk drive (CD), a digital versatile disk drive (DVD), and so forth. Examples of input/output module 726 may include, but are not limited to, a keyboard, a cursor control device, a display, a network interface, and so forth. In various embodiments, system 700 may be a wireless mobile phone, a personal digital assistant, a personal computer (PC), a network router, a set-top box, an audio/video controller, a DVD player, and a server.

Although specific embodiments have been illustrated and described herein, it will be appreciated by those of ordinary skill in the art that a wide variety of alternate and/or equivalent implementations calculated to achieve the same purposes may be substituted for the specific embodiment shown. This application is intended to cover any adaptations or variations of the embodiments discussed herein.

What is claimed is:

1. An apparatus comprising:
a communication bus to transmit signals to and from at least a first integrated circuit; and
an obfuscation circuit coupled to the communication bus to conditionally prevent external measurement of data signals on the communication bus.

2. The apparatus of claim 1, wherein the obfuscation circuit is adapted to cause the apparatus to irreversibly transition from a first state in which external measurement of the data signals may be performed, to a second state in which external measurement of the data signals is prevented.

3. The apparatus of claim 2, wherein the obfuscation circuit comprises a one-time programmable fuse or antifuse to influence when the apparatus transitions from the first state to the second state.

4. The apparatus of claim 1, wherein the obfuscation circuit further comprises a signal generator designed to conditionally drive a common mode noise signal onto the at least one pair of differential signal traces concurrent with the data signals.

5. The apparatus of claim 4, further comprising:
a receiver coupled to the integrated circuit via a common ground plane.

6. The apparatus of claim 1, wherein the communication bus comprises at least one pair of differential signal traces to transmit differential data signals.

7. The apparatus of claim 1, wherein the obfuscation circuit comprises:
an encryption circuit coupled to the communication bus on the communication bus; and
a decryption circuit coupled to the communication bus to decrypt the encrypted signals.

8. The apparatus of claim 1, further comprising:
at least one mirror port coupled the first integrated circuit, wherein the at least one mirror port is conditionally disabled based upon operation of the obfuscation circuit.

9. A method comprising:
driving a first signal on a communication bus;
determining an operating state for the bus; and
conditionally obfuscating the first signal to prevent external measurement of the first signal on the communication bus based at least in part upon the operating state.

10. The method of claim of 9, further comprising:
driving a second signal on the bus concurrent with the first signal to obfuscate the first signal.

11. The method of claim 10, wherein the first and second signals each comprise differential mode signals.

12. The method of claim 10, wherein the second signal is conditionally driven on the bus when in a protected state.

13. The method of claim 12, wherein the communication bus is irreversibly transitioned to the protected state.

14. The method of claim 9, further comprising:
recovering the first signal at a receiver coupled to the bus based at least in part upon a common reference signal shared by the receiver and the second driver.

15. The method of claim 14, wherein the common reference signal is provided to the receiver and the second driver via a common ground plane.

16. A system comprising:
a communication bus equipped to transmit signals;
a first integrated circuit coupled to the bus to transmit and receive data signals via the bus;
a second integrated circuit coupled to the bus to transmit and receive data signals via the bus; and
an obfuscation circuit coupled to at least one of the first and second integrated circuits to conditionally prevent external measurement of the data signals on the communication bus.

17. The system of claim 16, wherein the obfuscation circuit is adapted to cause the system to irreversibly transition from a first state in which external measurement of the data signals may be performed, to a second state in which external measurement of the data signals is prevented.

18. The system of claim 17, wherein the obfuscation circuit comprises a one-time programmable fuse or antifuse to influence when the system transitions from the first state to the second state.

19. The system of claim 16, wherein the obfuscation circuit comprises a signal generator designed to drive a common mode noise signal onto the at least one pair of differential signal traces concurrent with the data signals.

20. The system of claim 19, wherein the first and second integrated circuits share a common ground plane.

21. The system of claim 16, wherein the communication bus comprises at least one pair of differential signal traces to transmit differential data signals.

22. The system of claim 16, wherein the obfuscation circuit comprises:
an encryption circuit coupled to the communication bus to encrypted data on the communication bus; and
a decryption circuit coupled to the communication bus to decrypt the encrypted data.

23. The system of claim 16, further comprising:
at least one mirror port coupled to at least one of the first and second integrated circuits, wherein the at least one mirror port is conditionally disabled based upon operation of the obfuscation circuit.

24. The system of claim 16, wherein at least one of the first and second integrated circuits comprises a processor.
